(19) United States
(12) Patent Application Publication
(10) Pub. No.: US 2009/0002978 A1
(43) Pub. Date: Jan. 1, 2009

(54) Linear lighting system having a spinal structure and an optical system separately installable thereon

(76) Inventors: Michael Trung Tran, Oakland, CA (US); Xiaoping Wu, Vallejo, CA (US)

Correspondence Address: BEESON SKINNER BEVERLY, LLP, ONE KAISER PLAZA, SUITE 750, OAKLAND, CA, 94612, US

(21) Appl. No.: 12/151,732

(22) Filed: May 7, 2008

Related U.S. Application Data
(60) Provisional application No. 60/928,257, filed on May 7, 2007.

(51) Int. Cl. F21V 17/08

(52) U.S. Cl. 362/223

(57) ABSTRACT

A linear lighting system has a spinal structure or spine 11 and one or more elongated optical shade assemblies 13 attachable to the spinal wherein the spinal structure can be installed at a job site separately from the shade assemblies. The optical shade assemblies contain all of the more delicate optical components of the lighting system, such as a reflector 19 and diffuser cover 21, and can be shipped and handled separately from the more durable spinal structure of the lighting system, which includes system components such as lamp sockets 15, ballasts 18, and socket and ballast wiring. The spine includes multi-function bracket structures 35, 36, 80 which support the lamp sockets and which allow for the suspension, hanging or mounting of the spine and the joining of spine sections together in a continuous run.

### CROSS-REFERENCE TO RELATED APPLICATION

This application claims the benefit of U.S. Provisional Application No. 60/928,257, filed May 7, 2007.

### BACKGROUND OF THE INVENTION

The present invention generally relates to overhead linear lighting systems for producing lighting in an architectural space, and more particularly relates to linear lighting systems featuring continuous runs of fixtures configured to provide both a desired light distribution and a desired physical lighting design within the architectural space.

Linear fluorescent lighting that can be configured into continuous runs of lighting fixtures have been used for many years. Linear lighting systems are typically made up of individual linear lighting fixture units interconnected to achieve a desired physical look, as well as a desired distribution of light within the architectural space. The individual linear lighting fixture units used in such systems are designed and manufactured as complete units containing all of their structural, electrical, and optical components. These complete units are shipped to the job site, where they are installed.

The problem with the current practice of shipping complete lighting fixture units to a job site for installation is that some of the components of the lighting fixture, and particularly the optical elements, such as shades, reflectors, lenses, etc, are more susceptible to damage and require more care in handling than other components, such as ballasts, housings, electrical wiring and connections, and lamp sockets. The result is that the most delicate elements of the shipped lighting fixtures dictate the care that must be taken in handling the overall fixture, resulting in increased labor costs and increased risk that the more delicate lighting fixture components will be damaged as the fixtures are being installed.

### SUMMARY OF THE INVENTION

The present invention overcomes the above-mentioned problems associated with conventional linear lighting systems by providing a linear lighting system having optical components that can be shipped and installed separately from the more durable structural and electrical components of the lighting system. The invention particularly provides for a novel spinal structure for a linear lighting system, which is separate from the more delicate optical components of the fixture, and which can be installed at the job site without the need to handle the optical elements of the system. Only after the spinal structure is in place and is checked for its electrical, mechanical, and structural integrity, will there be a need to handle the optical components of the system. This can be done with the care appropriate to such components, which can be shipped in separate protective packaging.

Advantages and benefits of the invention other than mentioned above will be apparent from the following description of the illustrated embodiments of the invention.

### DESCRIPTION OF THE DRAWINGS

FIG. 1 is a graphical representation of a ceiling suspended linear lighting systems having optical assemblies separately installable on a spinal structure in accordance with the invention;

FIG. 1A is a graphical representation of a wall mounted version thereof;

FIG. 2 is an enlarged depiction of the of the end of the ceiling suspended linear lighting system shown in FIG. 1;

FIG. 3 is a sectional view of a spinal structure for a first embodiment of a lighting system in accordance with the invention;

FIG. 4 is a sectional view of the optical shade assembly that is installable on the spinal structure shown on FIG. 3;

FIG. 5 is a sectional view showing the optical shade assembly shown in FIG. 4 installed on the spinal structure shown in FIG. 3;

FIG. 6 is a top plan view of the optical shade assembly shown in FIG. 4;

FIG. 7 is a side-elevational of the middle portion of the spinal structure shown in FIG. 3;

FIG. 8 is a top plan view thereof;

FIG. 9 is a top plan view of the middle portion of the spinal structure shown in FIGS. 7 and 8 with optical shade assemblies attached thereto;

FIG. 10 is a side elevational view of one of the ends of a lighting system in accordance with the invention showing the spinal structure with an optical assembly and showing an end cap installed thereon;

FIG. 11 is a top plan view thereof;

FIG. 12 is an explode top plan view thereof showing the end cap partially removed;

FIG. 13 is a front elevational view of the filler plate of the optical shade assembly of the lighting system of the invention;

FIG. 14 is a side elevational view thereof;

FIG. 15 is top plan view thereof;

FIG. 16 is a sectional view of the lighting system shown in FIG. 5 adapted for connection to the end of a stem of a stem mounting system, such as in the wall-mounted lighting system shown in FIG. 1A;

FIG. 17 is a top plan view of an alternative form of a double-ended channel bracket for use with lighting system in accordance with the invention.

FIG. 18 is a top plan view of an alternative form for a single-ended channel bracket for use with lighting system in accordance with the invention;

FIG. 19 is an end elevational view thereof;

FIG. 20 is an exploded top perspective view of a spinal structure in accordance with the invention showing an alternative configuration for the spine's multi-function bracket structures;

FIG. 21 is an top perspective view of the joined spinal structure shown in FIG. 20 with adjacent optical assemblies installed on the spinal structure;

FIG. 22 is a top perspective view of the socket support bracket of the bracket assembly for the spinal structure shown in FIG. 20;

FIG. 23 is a top perspective view of the joiner bracket of the bracket assembly for the spinal structure shown in FIG. 20;

FIG. 24 is an exploded view of a portion of the bracket assembly of the spinal structure shown in FIG. 20;

FIG. 24A is a top perspective view of the portion of the bracket assembly shown in the FIG. 24 installed on the channel housing of the spinal structure;

FIG. 25 is a top perspective view of the bracket assembly of the spinal structure shown in FIG. 20 with the joiner bracket of the assembly exploded away;

FIG. 26 is a top perspective view of one end of an optical assembly installable on the spinal structure illustrated in the foregoing figures;

FIG. 27 is a top plan view thereof;

FIG. 28 is a top perspective view of the optical assembly illustrated in FIGS. 27 and 28 installed on the spinal structure of a lighting system in accordance with the invention the invention;

FIG. 29 is a top plan view of the channel housing of the invention showing access openings in the bottom of the housing;

FIG. 30 is a cross-sectional view of the spinal structure and installed optical assembly such as shown in FIG. 21;

FIG. 31 is an exploded view of the end of a fixture run for a linear lighting system in accordance with the invention with an end cap attached to the alternative bracket configuration shown in the foregoing figures; and

FIG. 32 is a top perspective view of the end of the fixture run shown in FIG. 30 when fully assembled.

### DETAILED DESCRIPTION OF THE ILLUSTRATED EMBODIMENTS

Referring to the drawings, the illustrated embodiments of the linear fluorescent lighting system, denoted by the numeral 10, include a continuous spinal structure 11 (sometimes herein referred to as simply the “spine”), aesthetic end caps 12, a separate optical assembly in the form of elongated optical shade assemblies 13 adapted for in-line attachment to the spinal structure between the end caps, and an aesthetic filler cap 14 for placement over the exposed spinal structure between optical shade assemblies. The spinal structure supports the system's lamp sockets 15 and the fluorescent lamps 17 held thereby, and contains all of the other relatively durable electrical components of the lighting system, such as the ballasts 18 and wiring (not shown). On the other hand, the elongated optical shade assemblies contain all of the more delicate optical components of the lighting system, in this case slotted reflectors 19 and outer crenulated diffuser covers 21, both of which require special handling to avoid breakage, scratching, or other damage that may affect the optical performance of the lighting system. Depending on the length of the lighting system, the continuous spinal structure can support one or more in-line fluorescent lamps or banks of two or more fluorescent lamps, and can be configured to receive one or more optical assemblies, most suitably one optical assembly for each of the in-line fluorescent lamps or fluorescent lamp banks. (In the illustrated embodiment, a bank of two side-by-side fluorescent lamps is shown.)

The spinal structure 11 includes continuous channel housing 23 having a small cross-sectional profile in relation to its length and forms the spine of the system to which other components of the system attach. The channel housing can be provided in different lengths according to the application, and two or more elongated housing sections can be joined together in continuous runs as hereinafter described. For example, the housing sections can suitably be provided in four foot lengths joined at their ends as hereinafter described into longer runs, for example, eight or twelve foot runs. The channel housing is suitably fabricated of bent sheet steel, though other materials and fabrication methods could be used, for example, housings fabricated of extruded aluminum. It is seen that the bottom wall 25 and side walls 27 of the housing form a continuous channel 29 for containing the lamp ballasts 18 and for providing a wire-way for the ballasts and lamp socket wiring. Cover plates 31 can be provided for covering the wire-way and ballast.

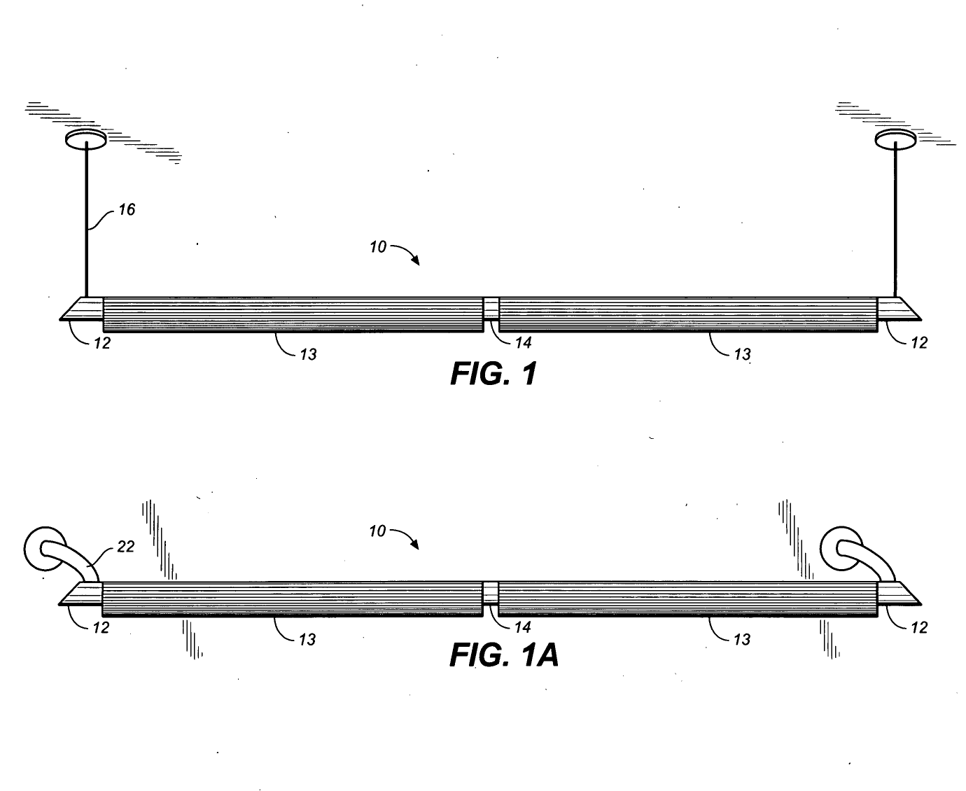

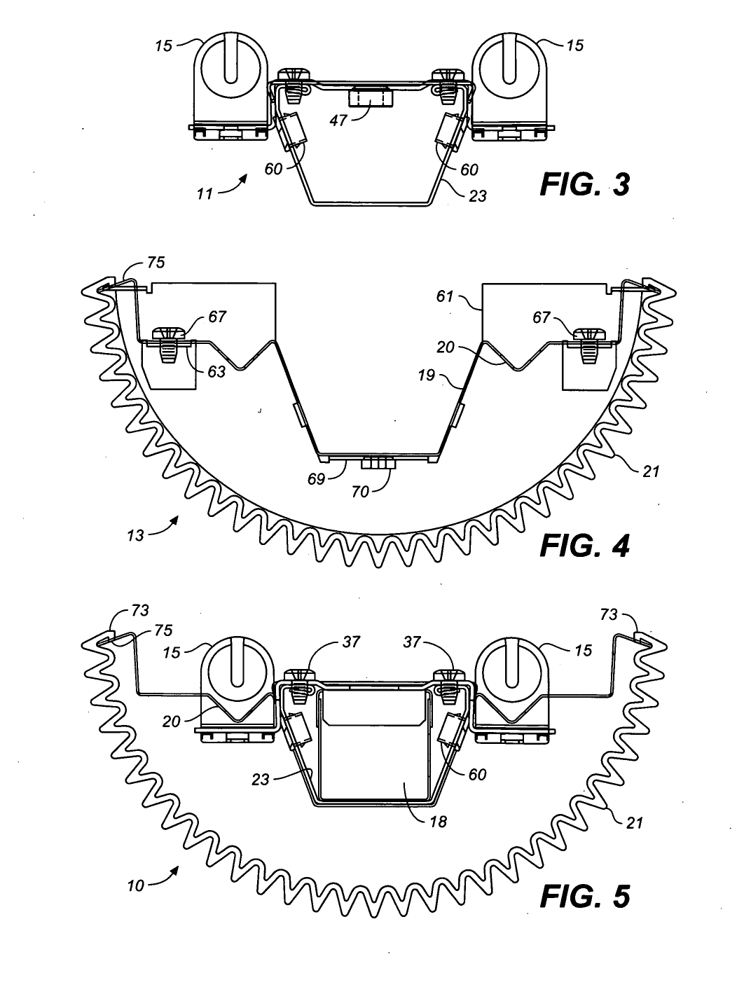

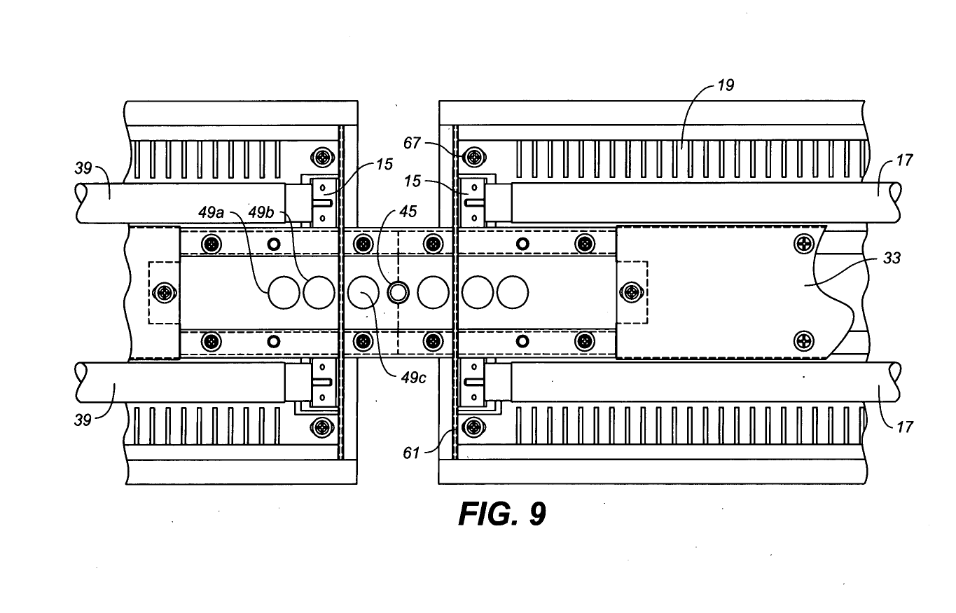

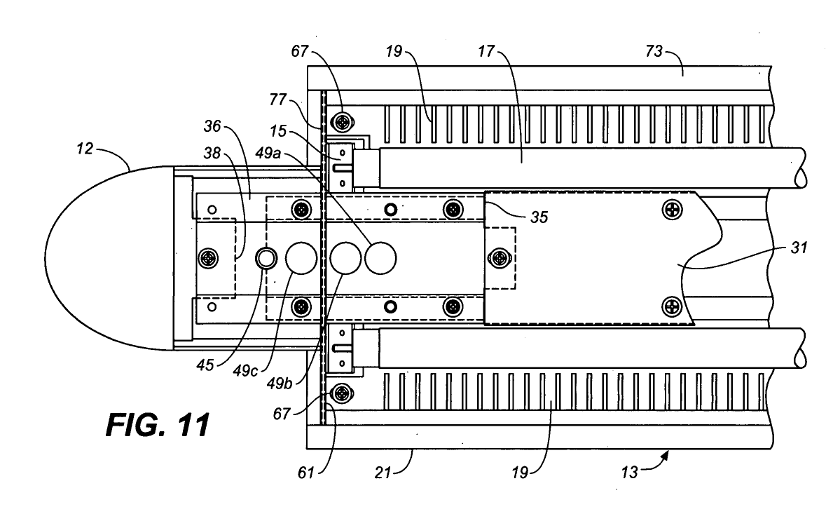

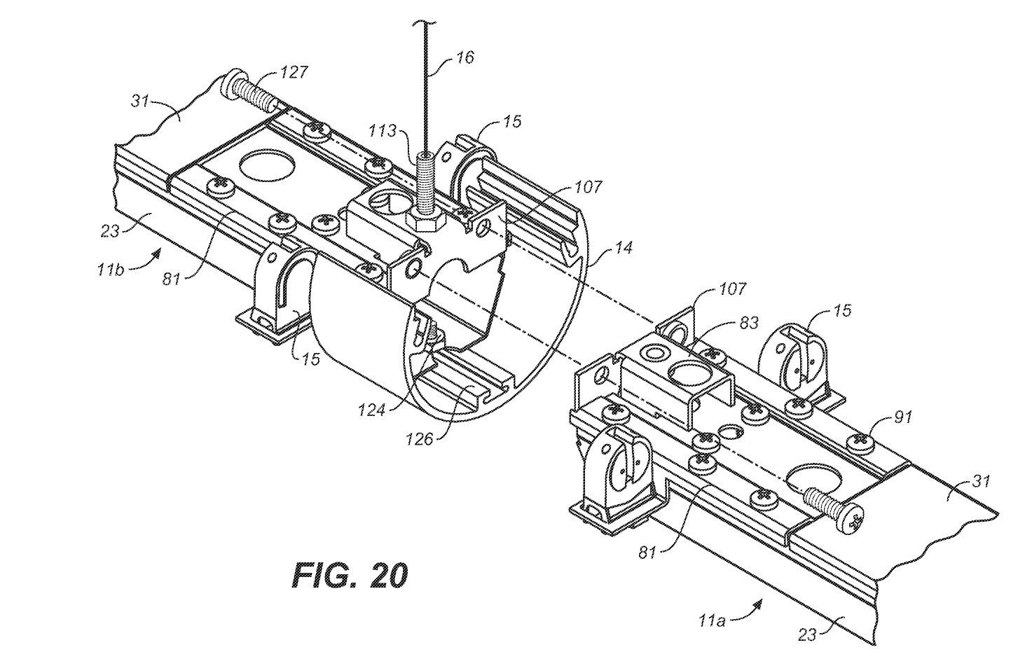

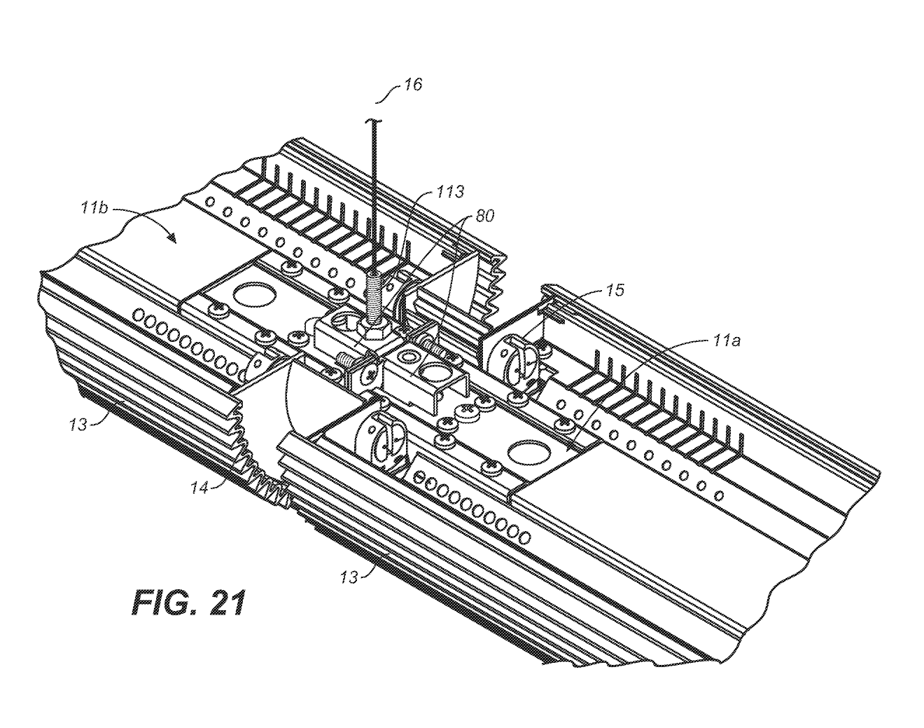

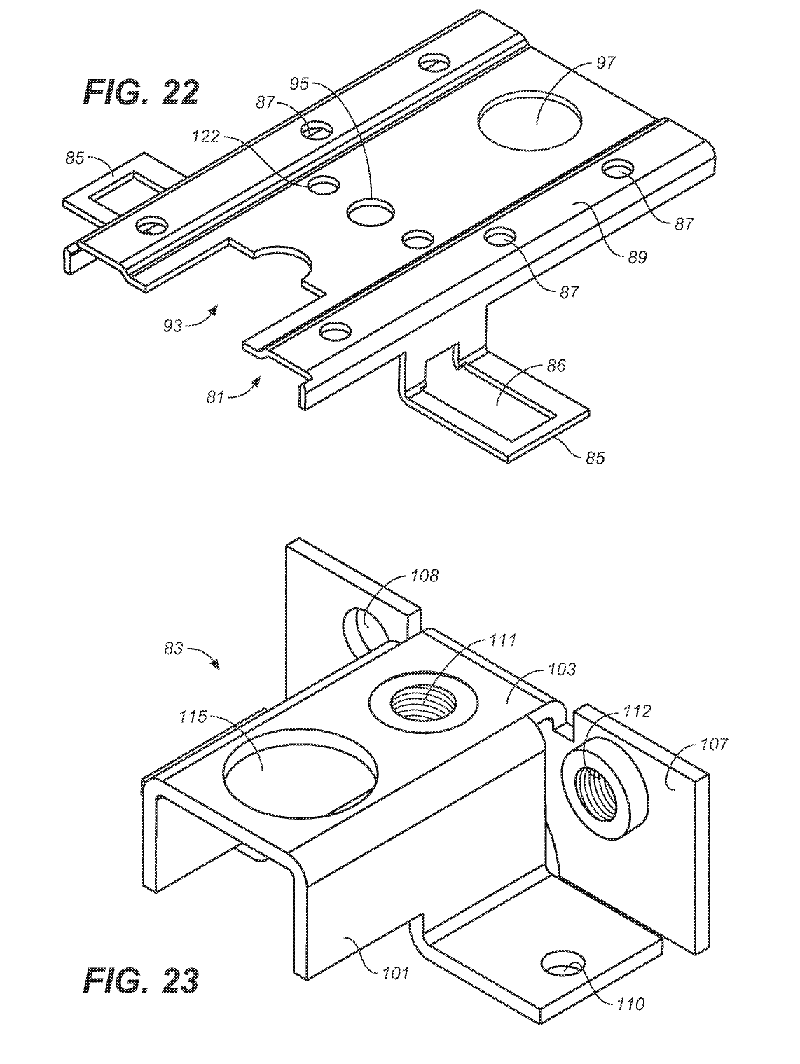

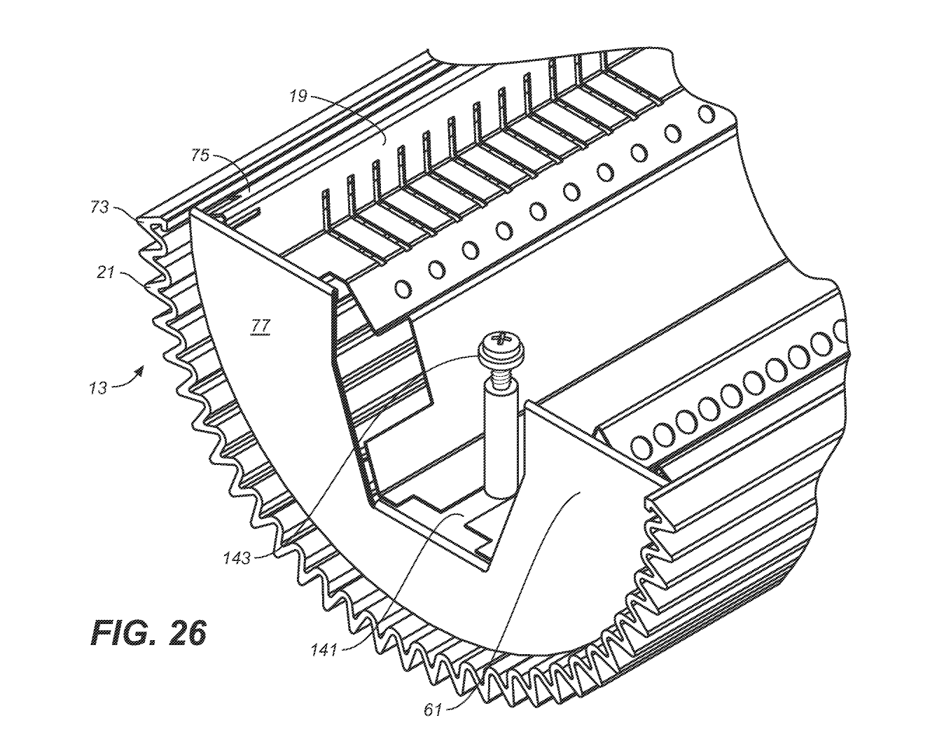

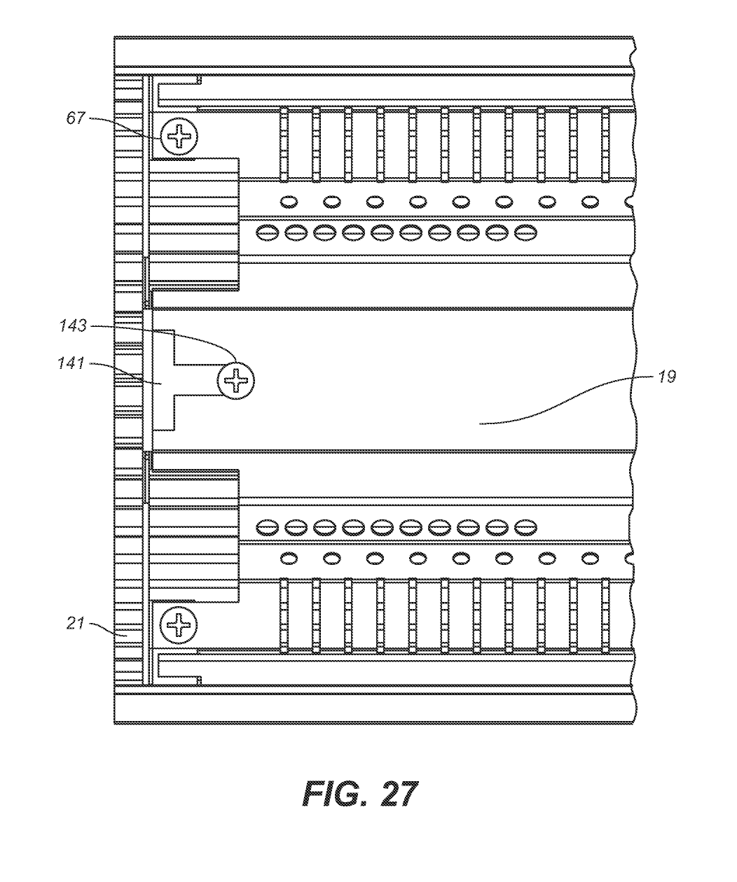

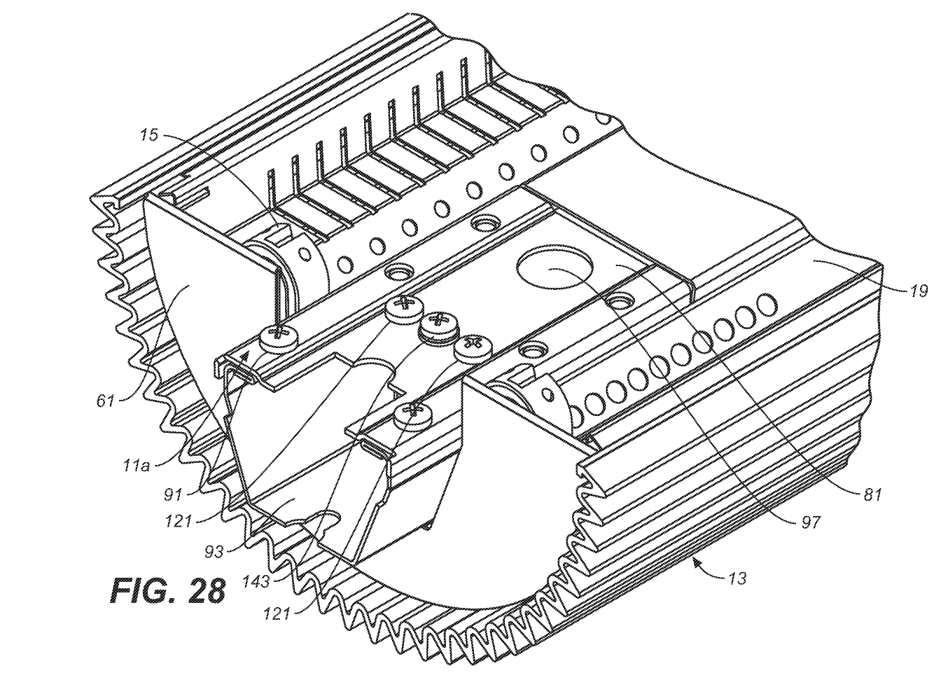

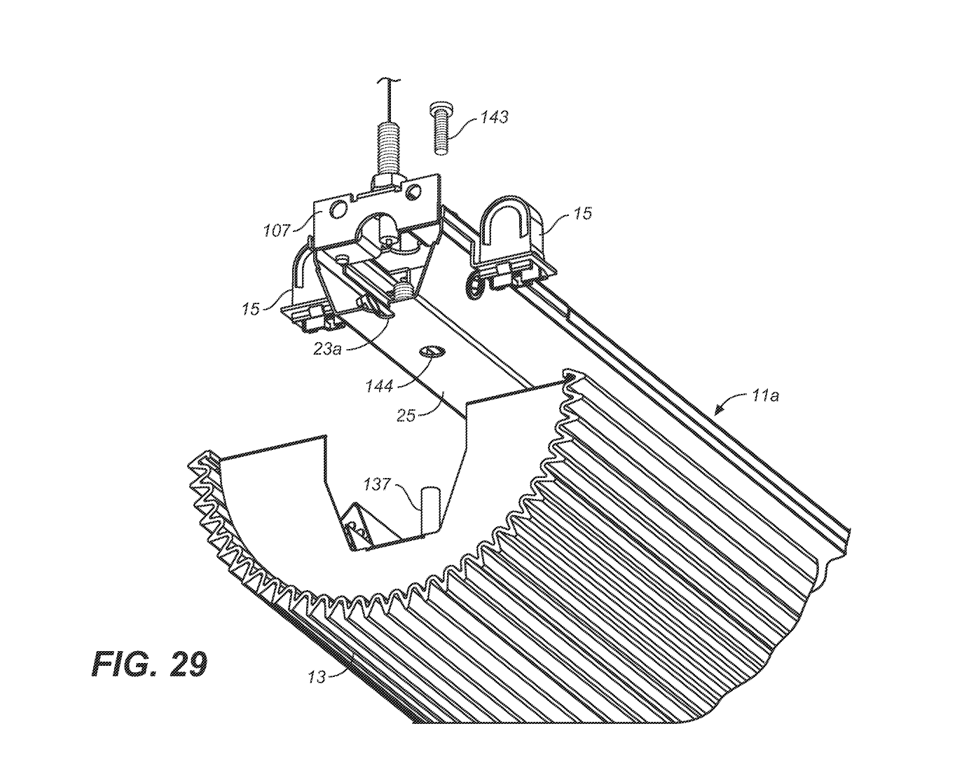

The spinal structure further includes spaced apart multi-function bracket structures, which in the embodiment illustrated in FIGS. 1-19 are in the form of socket support brackets 33, 35. In the hereafter described alternative embodiment of the invention shown in FIGS. 20-32, the spine's bracket structures are in the form of bracket assemblies having separate bracket elements.

Referring to FIG. 1-19, the socket support brackets 33, 35, which are suitably stamp metal parts, are affixed to the top of the channel housing at and, for suitably long runs, between the ends of the housing. These brackets have a primary function of supporting the lamp sockets 15 in their proper spaced relationship along the length of a housing run. They also serve as hanger brackets when located at mounting points or points of suspension for the lighting system. They can further function as a joiner bracket for joining the butt ends of two lengths or sections of channel housings to provide a channel housing in a continuous run.

The support brackets for the ends of the channel housing run are “single-ended,” in that they support lamp sockets facing in one direction only, whereas support brackets used between the ends of the housing run are “double-ended,” in that they support pairs of oppositely facing lamp sockets for holding adjacent in-line lamps or banks of lamps. The single-ended support brackets have a further function of providing a bracket structure to which the end caps 12 can be secured as hereinafter described. Both the single-ended and double-ended support brackets suitably attach to the top of the channel housing at their pre-defined locations by using sheet metal screws, such as screws 37, to screw the brackets to the housing's turned-in top edges 39. Corresponding screw holes 41, 43 are provided in housing's turned-in top edges and along the edges of the single-ended and double-ended support brackets for this purpose. Openings 49a, 49b, 49c provided along the center-line of the bracket provide access to the housing channel and, in the case of opening 49a, a mounting hole for a emergency light or switch as may be required by code.

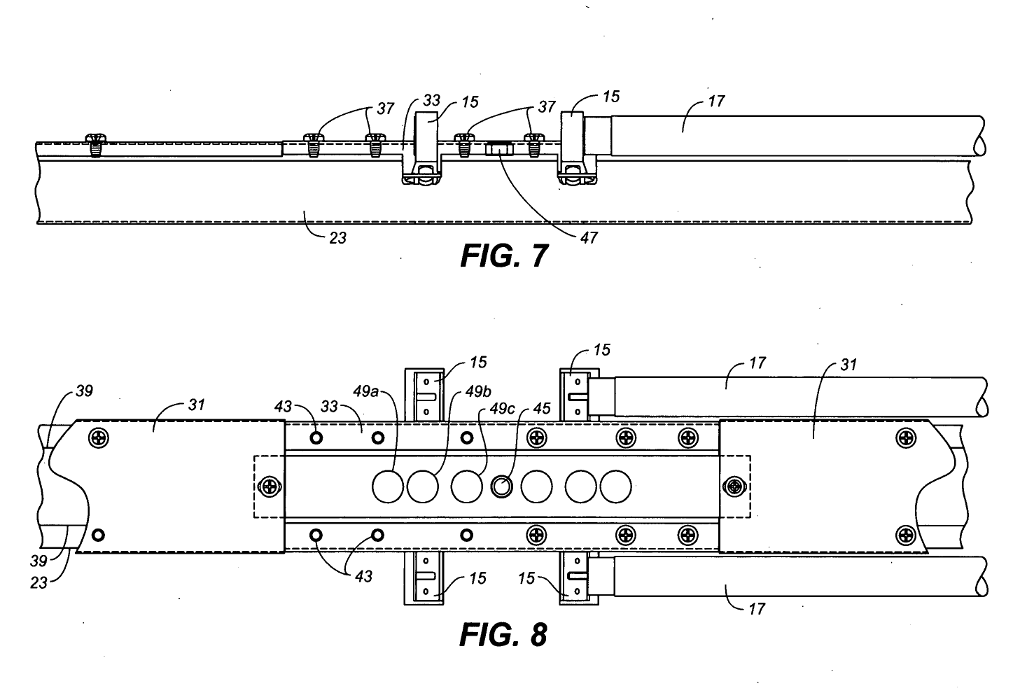

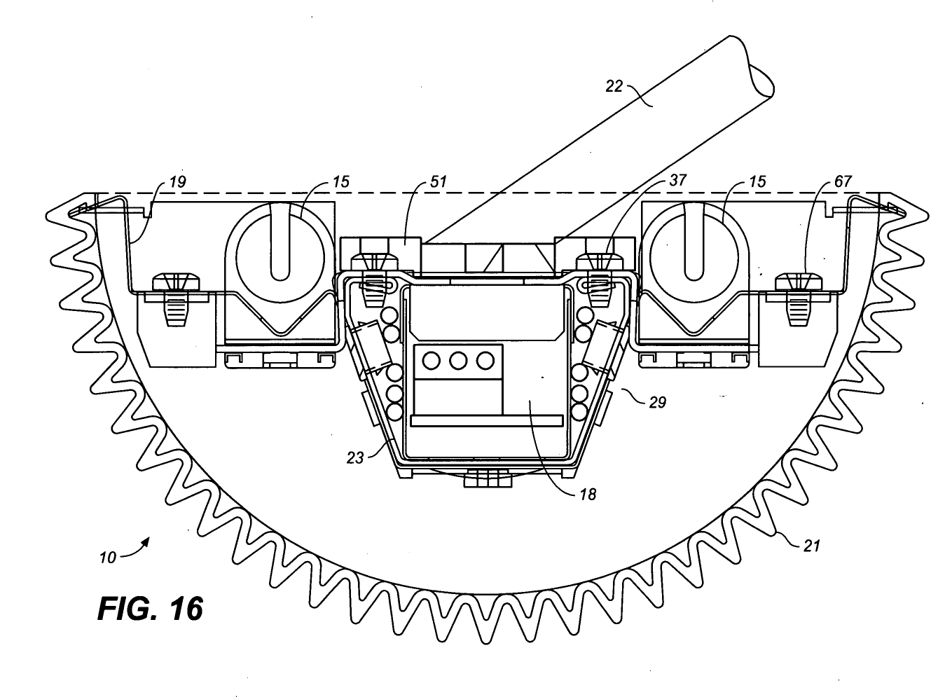

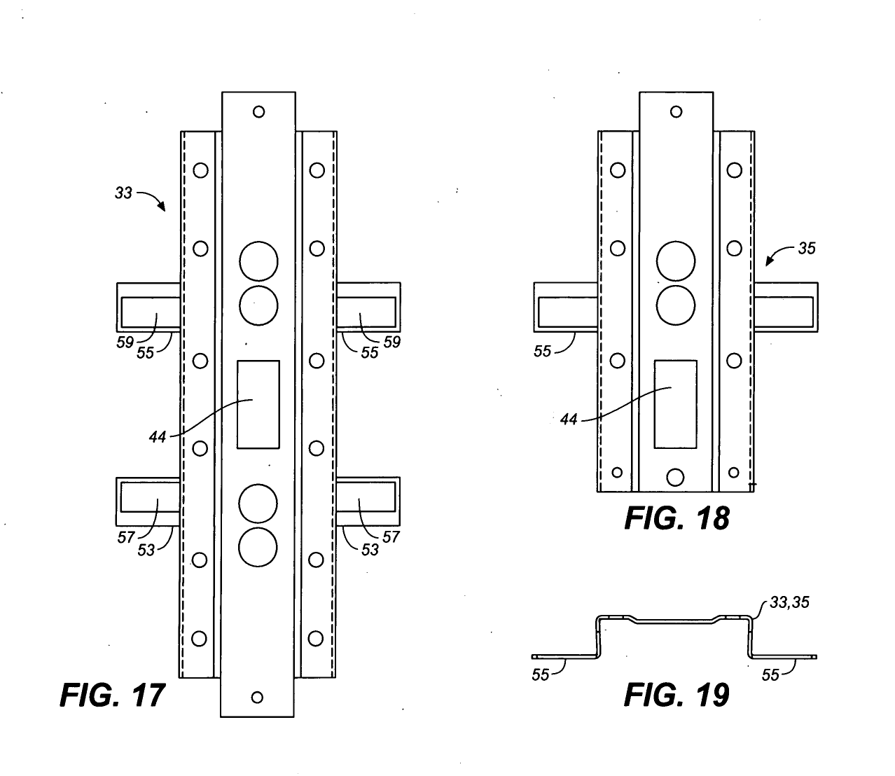

Each of support brackets 33, 35 are further suitably provided with a means of attaching a hanger cable or stem to the bracket to allow the bracket to serve as a hanger. In the embodiment illustrated in FIGS. 7-12, this attachment means is provided in the form of a attachment hole 45 backed by a threaded element, suitably in the self-clinching (PEM) nut 47 for attaching the drop end of a suspension cable. At the electrical feed to the fixture, a feed wire running down one of the suspension cables can be threaded into the elongated channel 29 of the spinal housing 23 through one of the hanger bracket openings 49c adjacent the bracket's attachment hole 45. As shown in FIG. 16, attachment of a rigid stem to a hanger bracket is suitably accomplished by attaching a separate mounting plate 51 to the top of the support bracket to which rigid stems—such as the illustrated rigid stem 52 of a wall mounted system such as shown in FIG. 1A—can be secured. For stem mounted lighting systems, the support brackets can suitably be provided with an enlarged opening 44 at the point of the stem connection. This opening is seen in the single-ended support bracket illustrated in FIGS. 16 and 17, and the double-ended support bracket illustrated in FIG. 16. The opening 44 shown in those drawings is large enough to accommodate quick-disconnect connector ends attached to the stem wiring.

As best seen in FIGS. 18-19, both the single-ended and double ended top channel plates have socket mounting tabs 53, 55 to which the lamp sockets can be attached. These mounting tabs extend laterally from the longitudinal side edges of the mounting plates and suitably have center openings 57, 59 into which a conventional lamp socket having a plastic snap-in casing can be inserted. In the illustrated embodiment, the socket mounting tabs are located along the edges of the support brackets so as to position the bank of two side-by-side lamps on the outside of the channel housing; the two in-line pairs of socket mounting tabs of the double-ended support bracket also provide desired separation between adjacent banks of lamps. As seen in FIG. 5, bushing 60 are provided in wire pull-through openings in the channel housing side walls 27 to protect the socket wires.

The double and single-ended support brackets illustrated and described herein are the preferred hardware configurations for providing the hanger, joiner, and socket support functions within the spinal structure of the lighting system. Such multi-function brackets can be easily installed and readily manufactured as stamped metal parts. However, it will be understood that other hanging/joiner hardware configurations are possible and considered within the scope of the invention, including hardware that provide the hanging, joining and socket support functions by means of separate parts, such as, for example, in the embodiment shown in FIGS. 20-32 hereinafter described.

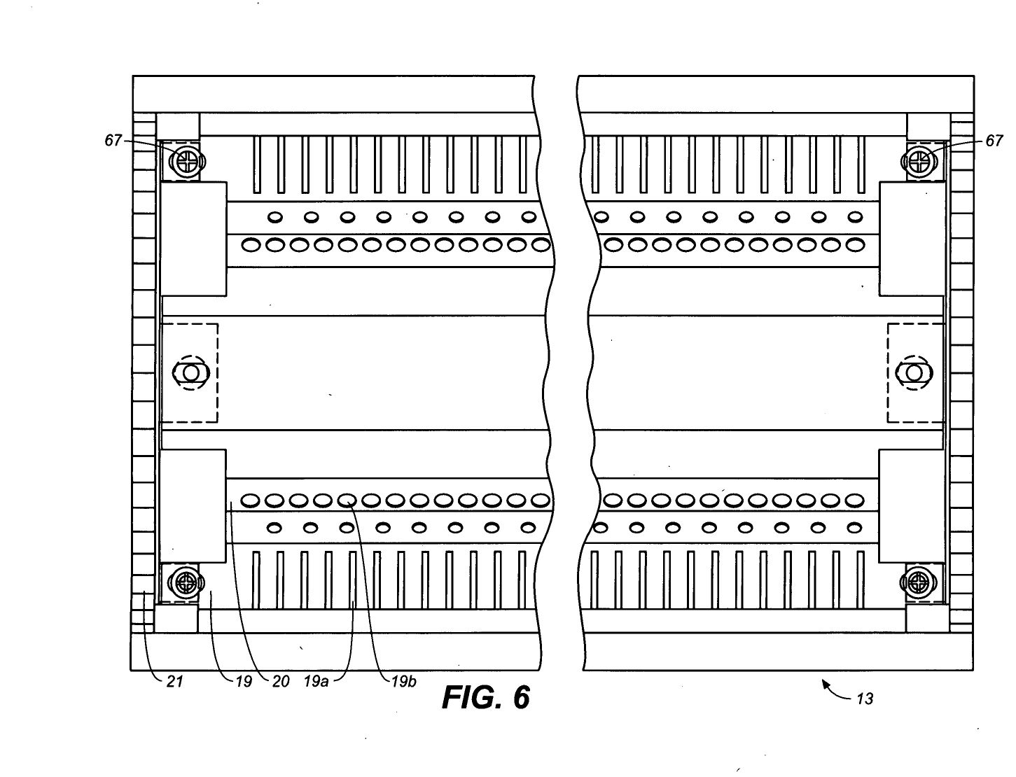

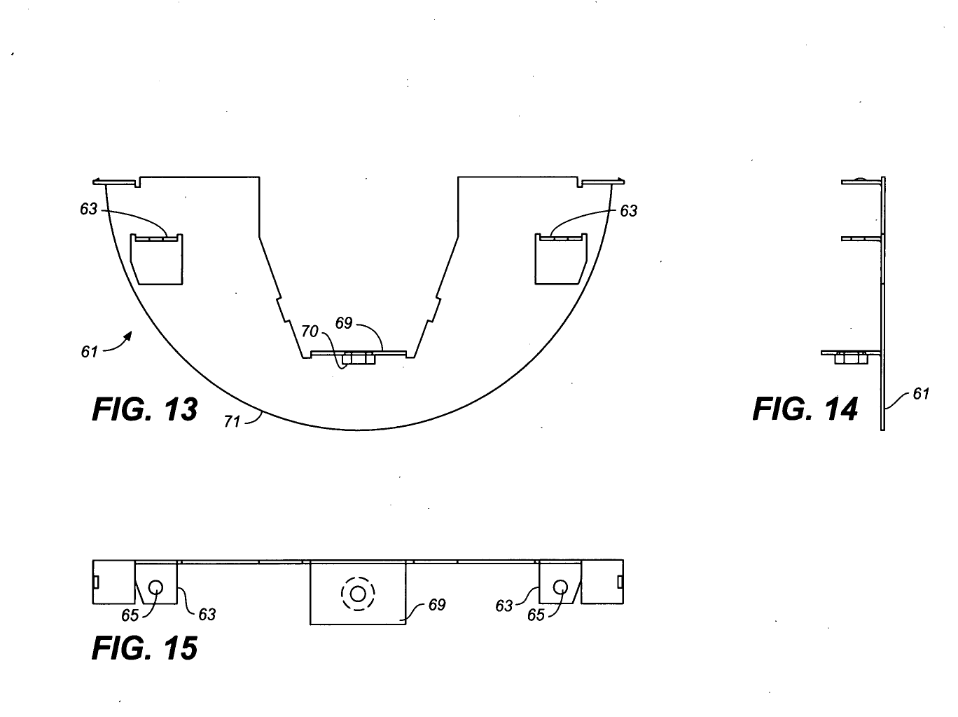

As above-mentioned, each of the optical shade assemblies 13 of the illustrated embodiment include optical elements in the form of a 19 and an outer diffuser cover 21. As best shown in FIG. 6, the illustrated reflector 19 is seen to include a V-channel 20 over which the lamps held by lamp sockets 15 will be positioned when the optical assembly is installed. The reflector is seen to further include a series of slots 19a in the reflector surfaces adjacent the V-channel and perforations 19b in the V-channel. The purpose of these slots and perforations, which suitable extend over the length of the reflector, is to pass light emitted by the lamps held by the lamp sockets to the diffuser cover 21. A filler end plate 61, such as shown in detail in FIGS. 13-15, is attached to each end of the reflector of the assembly by means of upper projecting tabs 63 having screw holes 65. These tabs slip under the edges of the reflector and allow for fastening of the filler plates to the reflector using screws 67. The filler end plate's lower projecting tab 69 with PEM nut 70 provides a means for attaching the assembled optical shade assembly to the bottom of the channel housing as hereinafter described. Other means of attaching the optical assembly to the channel housing are possible, including providing a snap-in spring clip construction (not shown) that allows the optical assembly to simply be snapped into place at appropriate locations along the spine of the system.

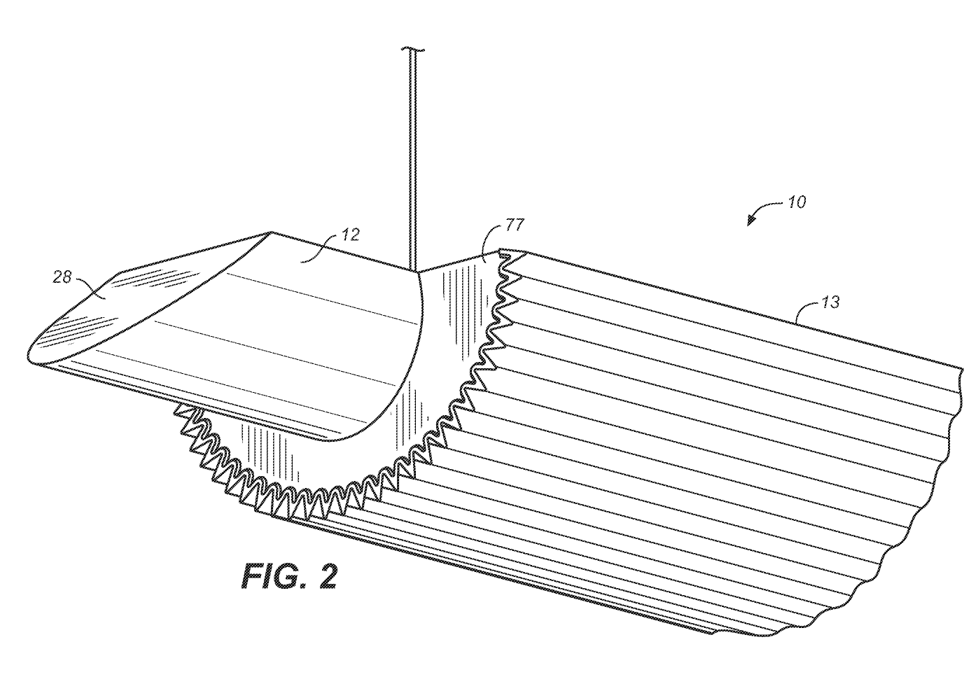

It is seen that the filler end plates 61 of the optical assembly each have a curved bottom edge 71 that conforms to the curved shape of the assembly's crenulated diffuser cover 21, however, other bottom edge configurations are possible. For example, the bottom edge of the filler plate could be serrated to conform to the shape of the shown crenulated diffuser cover. (Such an Edge Shape is Shown in FIG. 2.)

Once the end plates are installed on the reflector, the inwardly turned top rim 73 of the diffuser cover, which is suitably a flexible plastic, can be snapped or slid over the top longitudinal edge 75 of the reflector 19 to hold the diffuser cover in place. It is noted that at the outside surface 77 of the filler plates can be provided with a specular surface (or covered by a specular material) to enhance the aesthetic appearance of the lighting system. Such a specular surface is particularly advantageous at the very ends of the lighting system run (surface 77 in FIGS. 2, 8 and 9) which in many or most installations will be easily visible to observers circulating in the vicinity of the lighting system.

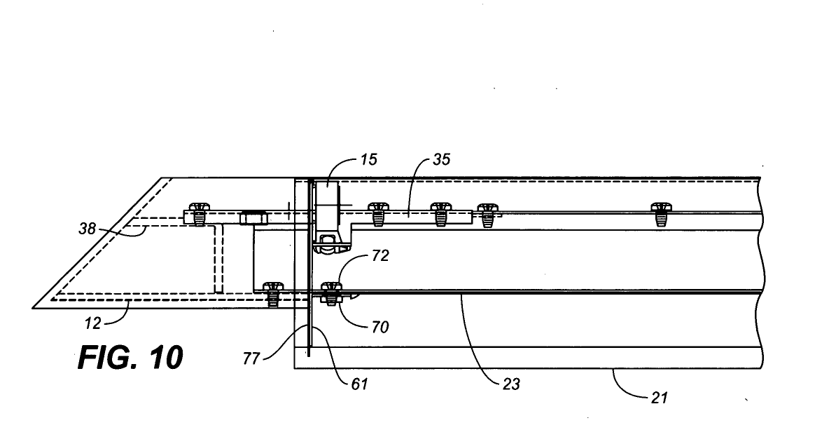

The above described optical shade assemblies 13 can be installed on the previously installed spine of the lighting system by lifting a complete optical assembly up to the spine and using screws 72 (see FIG. 10) to attach the assembly to the spine at each end of the optical assembly. To attach the optical assembly, screws 72 are inserted down through openings (not shown) in the bottom of the channel housing 23 near the assembly's filler end plates and screwed into the PEM nuts 70 on the projecting tabs 69 of the filler end plates. To screws are inserted from the top of the housing channel through access openings 49b provided in socket support brackets 33, 35.

The aesthetic linear characteristic of the lighting system 10 can be enhanced by the addition of the end caps 12, which project from the ends of the in-line elements of the lighting system. The end caps suitably are provided with a shape that is complementary to the exposed optical elements of the optical shade assemblies of the system so as to continue the form of the system. In the illustrated embodiment, this is a cut tubular shape mirroring the semi-cylindrical form of the crenulated diffuser cover of the optical shade assemblies, with an angled end wall 78 being provided to extend the shape and add to the aesthetic appeal of the end cap. By providing a specular surface 77 at the ends of the lighting system run, the tubular end cap will be reflected in these end surfaces to enhance the in-line appearance of the overall system.

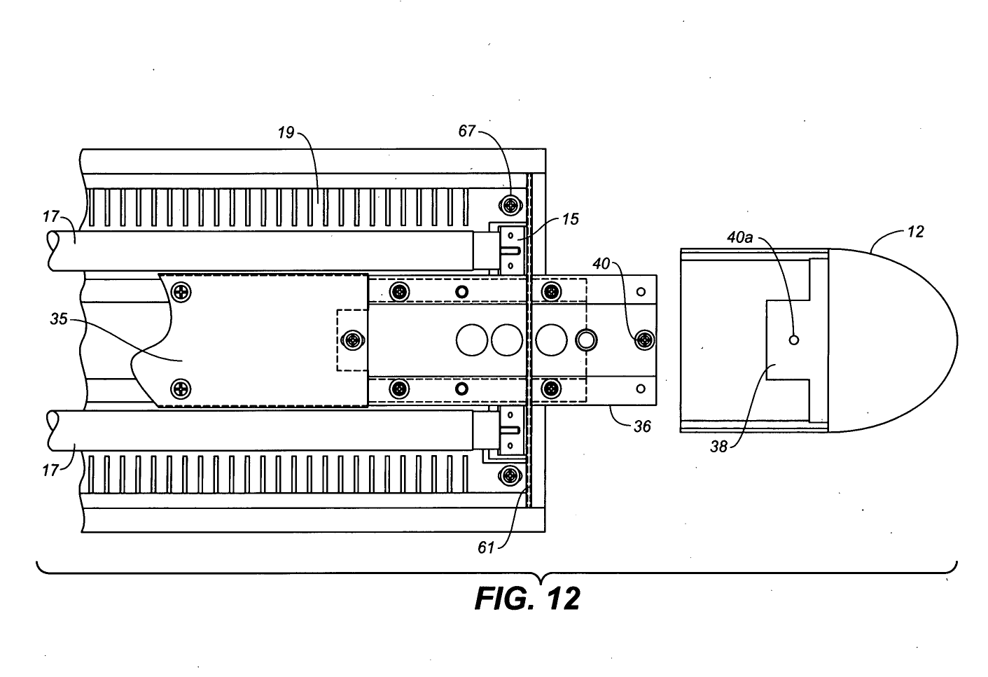

As shown in FIGS. 10-12, the end caps 12 can be joined to the ends of the spinal structure of the lighting system by means of the single-ended support brackets 35, which are mounted to the top of the channel housing at each end of the run in a manner similar to the double-ended support brackets. A means for joining the end cap to the single-ended support bracket is best illustrated in FIG. 12. There end cap 12, which is suitably fabricated of cast aluminum, is attached to the projecting end 36 of the single-ended support bracket by suitable screw attachments. The end cap 12 is seen to fit over the projecting end 36 of single-ended support bracket 35 such that an horizontal mounting plate 38 internal to end cap slides underneath the top of the support bracket. The end cap is secured in place by means of an attachment screw 40 which, when inserted through a hole in the mounting bracket, can be screwed into screw hole 40a on the end cap's internal mounting plate. It is noted that the projection of the single-ended support bracket beyond the end of the optical shade assembly advantageously permits the lighting system suspension points at the ends of the fixture run to be positioned to the outside of the optical assembly 13 and the lamps 17 and lamp sockets 15 covered by the optical assembly. The suspension point is positioned outside the end of the optical assembly by placing the mounting hole 45 for the drop end of a suspension cable in the support bracket's projecting end. The aesthetic end cap covers this relatively unsightly projecting end of the support bracket and to provides a pleasing termination to the lighting system run. It will be understood that the aesthetic end caps are an optional aesthetic feature of the lighting system of the invention, and that these end caps could be omitted. The projecting ends of the single-ended support bracket could also be omitted, in which case the suspension points at the ends of the fixture runs would have to be inboard the ends of the optical assemblies.

It is noted that where two or more optical shape assemblies are attached along the spinal structure of the invention, as shown, for example, in FIG. 1, a gap exists between adjacent optical shape assemblies. Here the bottom of the channel housing 23 would normally be exposed. This relatively unsightly short section of the channel housing is preferably covered by a decorative filler cap 14, which can attached by any suitable means to the channel housing, such as by spring clips or screw attachments (not shown). The shown filler cap 14 is seen to have a cylindrical shape that mirrors the tubular shape of the end caps and that complements the overall form of the lighting system.

To install the lighting system, the spinal structure 11 is suitably pre-assembled at the factory, and separately shipped to a job site. The separately shipped spinal structure would include the ballasts, wiring, support brackets and lamp sockets. Since none of the components of the spinal structure are exposed or particularly fragile, workers at the job site can handle this structure without having to exercise a high degree of care. This would include hanging (suspending) or mounting the continuous spinal structure in place, as required by the architectural plans, prior to installing the optical shade assemblies. The spinal structure can be pre-assembled in sections to be installed in longer runs at the job site. Such spinal sections can be joined together at the job site by the above-described double-ended support brackets. The more delicate optical shade assemblies can be shipped to the job site in separate packaging designed to prevent damage to the shade assemblies during transit. Once the spinal structure has been installed and wire connection made, the optical shade assembles can by removed from their protective packaging and installed along the continuous spinal structure, using the care required for these more delicate components. Once the optical shade assemblies have been installed, the installation can be completed by attaching the end caps 12 and filler cap or caps 14 as above-described.

In FIGS. 20-32, an alternative configuration for the spine's multi-function bracket structures is shown. In this embodiment, the need for separate single-ended and double-ended bracket configurations are eliminated and a mechanism is provided for mechanically joining the ends of separate sections of the spinal structure in a tight abutting relationship. Also, this configuration simplifies installation of the optical assemblies on the spinal structure with more accessible attachments.

With further reference to these figures, the spinal structure 11 of the lighting system 10 is shown as including spinal structure sections 11a and 11b joined together to form a continuous spine onto which the optical shade assemblies 13 of the lighting system can be installed. In this embodiment each bracket structure is identical to the other bracket structures and is designed for installation on any end of the spinal sections. In addition to being used to join spinal sections together, it will be seen that the same bracket structure is used at the end of a run of spinal sections for both providing suspension points at the ends and for attaching the end caps 12a.

More specifically, each bracket structure of this embodiment is in the form of bracket assembly 80 comprised of a single-ended socket support bracket 81 and a joiner bracket 83, both suitably fabricated of galvanized steel. Support bracket 81 is similar to the single ended support bracket 35 of the previously described embodiment, and includes laterally extending socket mounting tabs 85 and screw holes 87 along its longitudinal edges 89 for mounting the bracket to the top of a channel housing 23 by means of mounting screws 91. End slot 93 and one or more openings 95, 97 suitably provided along the centerline of the support bracket perform various functions, including in the case of end slot 93 allowing a power cord to by pulled through the top of the bracket assembly as hereinafter described, and in the case of opening 95, which is inboard end slot 93, providing a point of attachment for the optical shade assemblies when installed as hereinafter described. The larger opening 97 can act as a auxiliary mounting hole for an emergency light or switch required by most building codes. A knock-out can suitably be provided for this opening for creating an opening as needed.

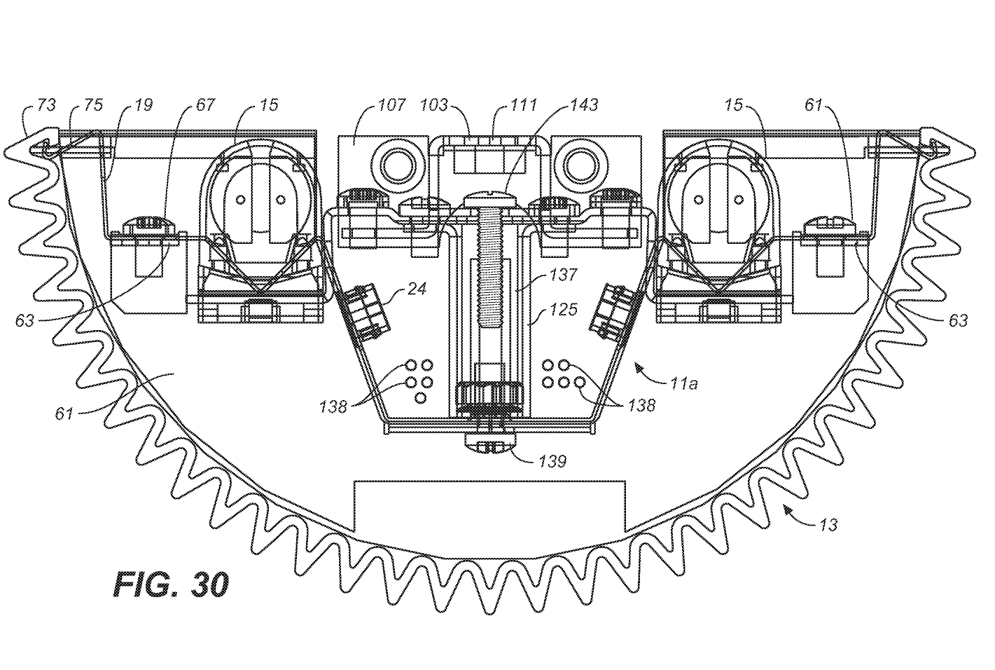

The joiner bracket 83 the bracket assembly 80 is suitably provided as a separate part positioned on top of and at the end of the support bracket 81 above the support bracket's end slot 93. This bracket, which is used both to join two spinal sections together and to provide a hanging or suspension point for the spinal structure, includes a longitudinally extending U-shaped body 101 having an elevated top wall 103 and side walls 105. It further includes a vertical joiner plate 107 extending laterally of the U-shaped body, and horizontal wing plates 109 laterally extending from the base of the body's side walls 105. The elevated top wall 103 is provided with a suspension cable attachment hole 111 which, as best seen in FIG. 30, is backed by a PEM nut into which the threaded connector 113 at the drop end of a suspension cable 16 can be screwed when the spinal structure is installed. A power cable access opening 115 is provided adjacent cable attachment hole 111 so that a power cable at electrical feed locations can be threaded into the housing channel through the joiner bracket and the end slot 93 of the underlying socket support bracket.

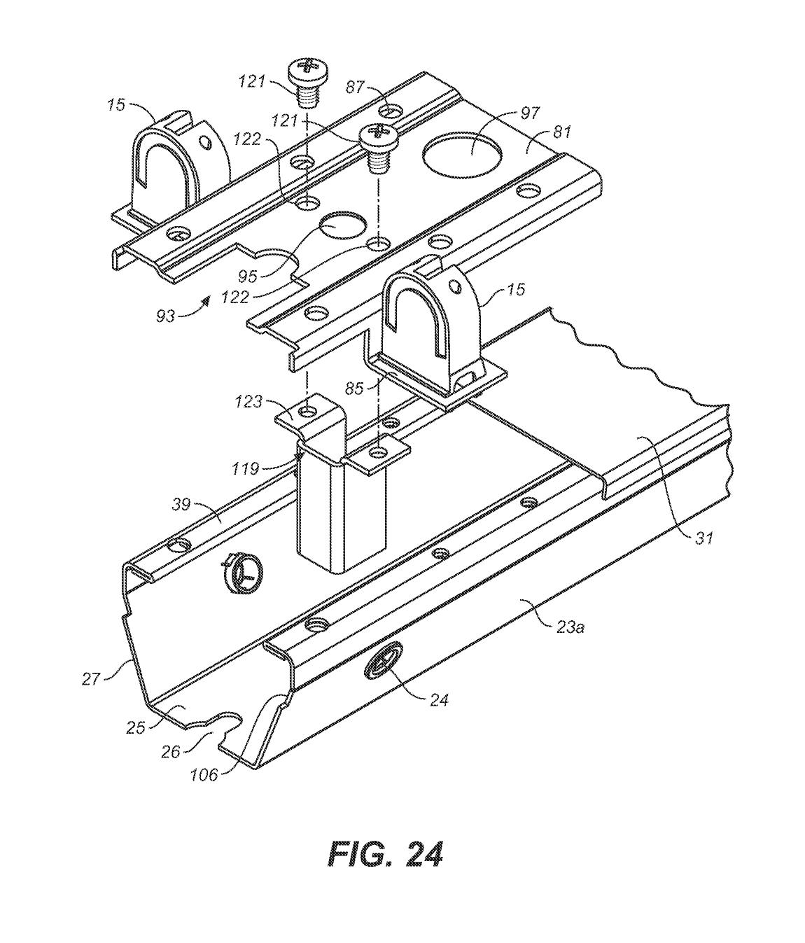

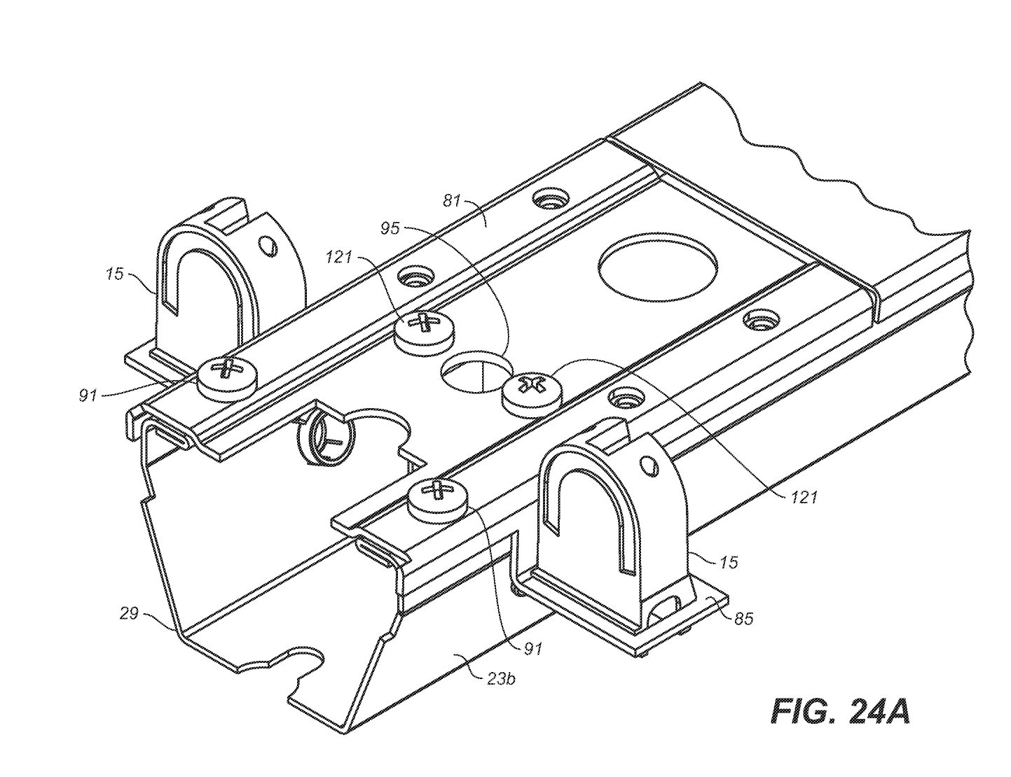

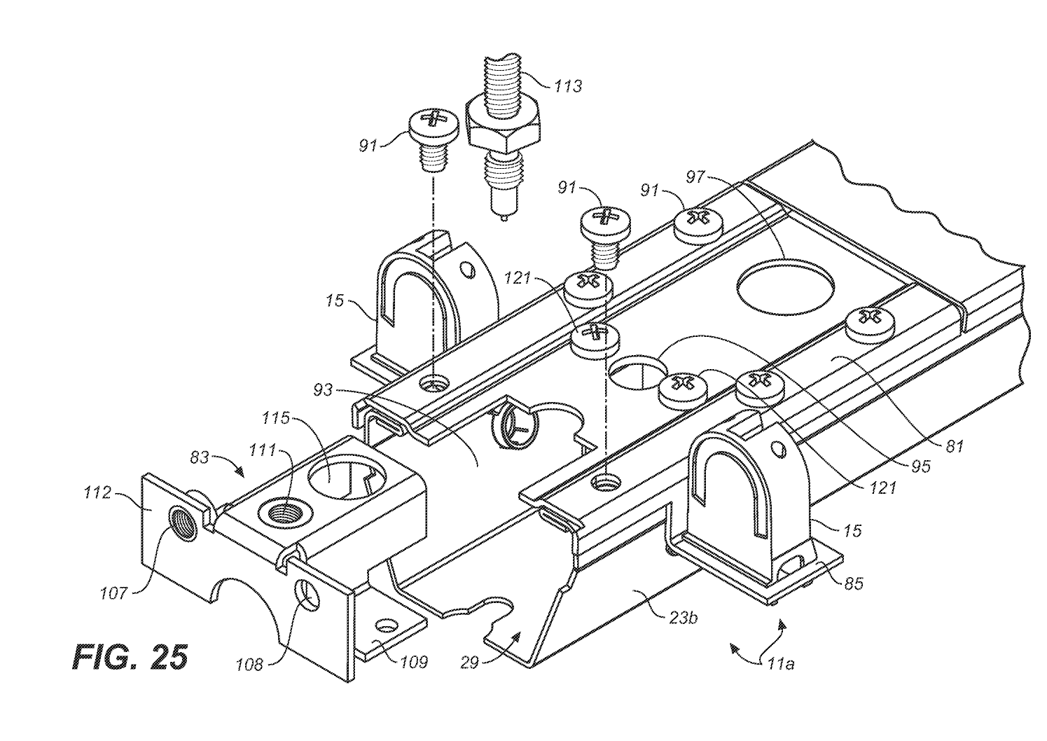

Installation of the bracket assembly at the end of a spinal section is further described in reference to FIGS. 24-25. Referring to FIG. 24, the socket support bracket 81 is placed over the end of a channel housing section, such as channel housing section 23a, suitably with a wire separator 119 attached to the bottom of the support bracket. The wire separator has sufficient length to extend substantially all the way down into the housing channel and keeps the wires in the housing channel away from the center of the wire-way formed by the housing, thereby preventing the wires from interfering with the later installation of a optical shade assembly as later described. As shown in FIG. 23, the wire separator is attached to the underside of the support bracket by means of screws 121, which screw into laterally extending tabs 123 at the top of the vertical body 125 of the wire separator.

The support bracket is attached to the top of the channel housing by means of screws 91, suitably sheet metal screws that screw into the channel housing's turned-in top edges 39. As best shown in FIG. 25, this is done with the joiner bracket placed over the end of the support bracket with the wing plates 109 of the joiner bracket positioned under the turned-in edges of the channel housing so that the end most screws for attaching the support bracket to the top of the channel housing will additionally screw into the holes 110 of the joiner bracket's wing plates for holding the joiner bracket to the socket support bracket. Commercially available plastic lamp sockets are suitably snapped into the openings 86 in the socket mounting tabs 85 of the socket support plate either before or after the bracket assembly is installed on the channel housing. The socket wiring (not shown in FIGS. 24-25) would be pulled through suitable wiring grommet holes 24 in the sides of the channel housing underneath the lamp socket positions.

It is contemplated that each spinal section comprised of a channel housing 23, bracket assemblies 80, a ballast (not shown), lamp sockets 15 and the associated wiring will be pre-assembled at the factory and shipped to a job site for installation. Suitably the spinal sections would come in nominally foot lengths, however, spinal sections could be provided in other lengths. A filler cap 14 is suitably pre-attached to one end of each spinal section and can be removed as required when the filler cap is not required as when an end cap is used instead. As shown in FIG. 20, attachment of the filler cap, which is suitably an extruded aluminum part, can be accomplished by a T-slot screw (T-stud) and nut 124 fitted into a T-slot 126 extruded into the bottom of the filler cap. (A slot 26 is provided in the channel housing bottom wall 25 to accommodate the T-slot screw.) It is further contemplated that the wiring for each spinal section will be provided with a male quick connector at one end (not shown) and a female quick connector at the other end (also not shown) such that electrical connections between spinal sections or to a power cord can readily be made. For long runs of spinal sections, several power drops will likely be required, for example, one power drop for each of five four foot spinal sections.

As best shown in FIG. 20, two spinal sections, such as the illustrated sections 11a, and 11b, can be joined together by placing the end of one section against the end of the other section so that the vertical joiner plates 107 of the joiner brackets 83 at the ends of the spinal sections abut each other. In this abutting relation, the joiner plates can be secured. Prior to joining the ends of the spinal sections the appropriate wiring connections will be made, suitably using the above-described quick connectors.

In the illustrated embodiment the joiner plates are secured by securement screws 127 inserted from opposite sides of the vertical joiner plates into an opening provided 108 provided on one end of the joiner plate which aligns with a PEM nut backed opening 110 on the other end of the opposite joiner plate. It is noted that small notches 106 are provided in the ends of the channel housing sections (see FIG. 24) to allow the vertical joiner plates of the joiner bracket to recess into the channel housing ends. This will allow the spinal section ends to mate together without gaps.

After the spinal sections of the lighting system shown in FIGS. 20-32 are installed at an installation site, the separately packed and more delicate optical shade assemblies are attached to the spinal sections. In this version of the lighting system (FIGS. 20-32), the optical shade assemblies 13 are nearly identical to the optical shade assemblies for the previously described version, except for the mechanism for attaching the optical shade assembly to the spinal structure of the lighting system. Each optical shade assembly is comprised of a reflector 19, filler end plates 61 (shown in FIG. 13-15), which preferably have an outer specular surface 77 and are attached to the ends of the reflector, and a crenulated diffuser cover 21 having inwardly turned top rims 73 that slide or snap over the longitudinal top edges 75 of the reflector. However, here a vertical stand-off sleeve 137 is attached to the projecting tab 69 of filler plate 61 by bottom attachment screw 139 as shown in FIG. 30. Cut-outs 141 in the ends of the reflector are provided to accommodate this stand-off sleeve when the filler plates are attached to projecting tabs 63 on the filler plate by screws 67. Here too it is contemplated that the optical shade assemblies will be pre-assembled at the factory for shipment to the job site.

To attach an optical assembly 13 on an installed spinal section, such as spinal section 11a and 11b, the assembly is lifted up to the spinal section so that the vertical stand-off sleeves on either end of the assembly can be inserted through openings 144 provided in the housing's bottom wall 25 below the wire separators 119, whereupon the assembly is raised until the stand-off sleeves extend through the wire separators to the openings 95 in the top wall 103 of the joiner brackets at each end of the assembly. When raised to where the stand-off sleeves are fully inserted through the wire separators, the stand-off sleeves are screwed in place by the attachment screws 143, thereby holding the optical shade assemblies to the spinal section. As above-mentioned and as illustrated in FIG. 30, the wire separator will keep the wires 138 in the housing channel away from the center of the channel so that the wires do not interfere with the optical shade assembly's installation.

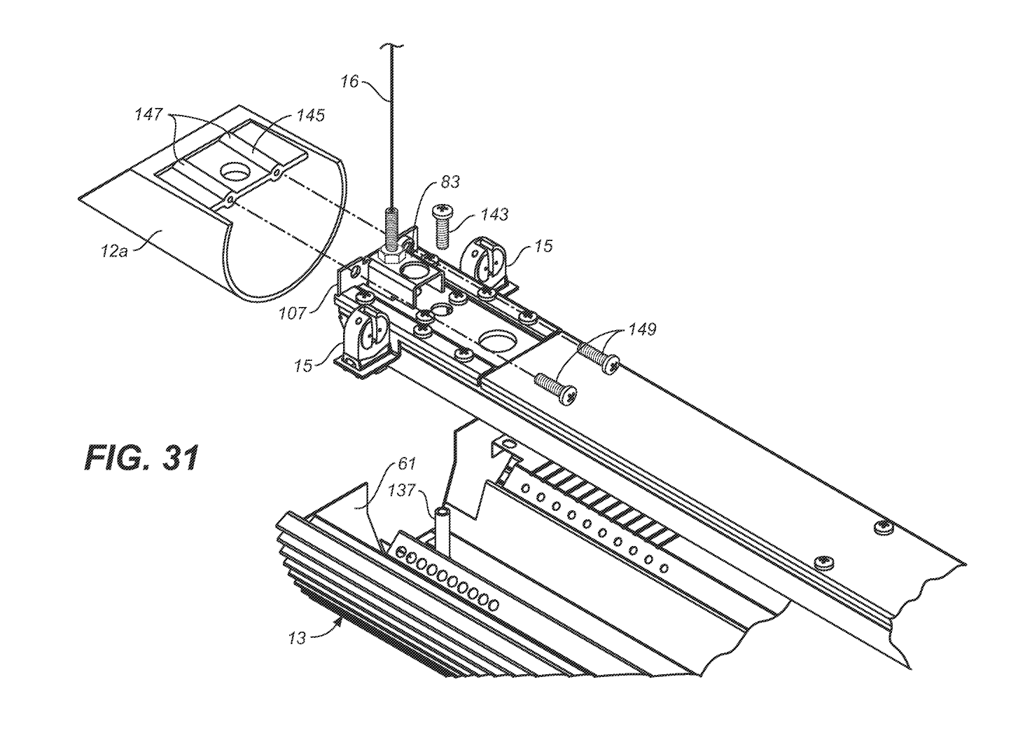

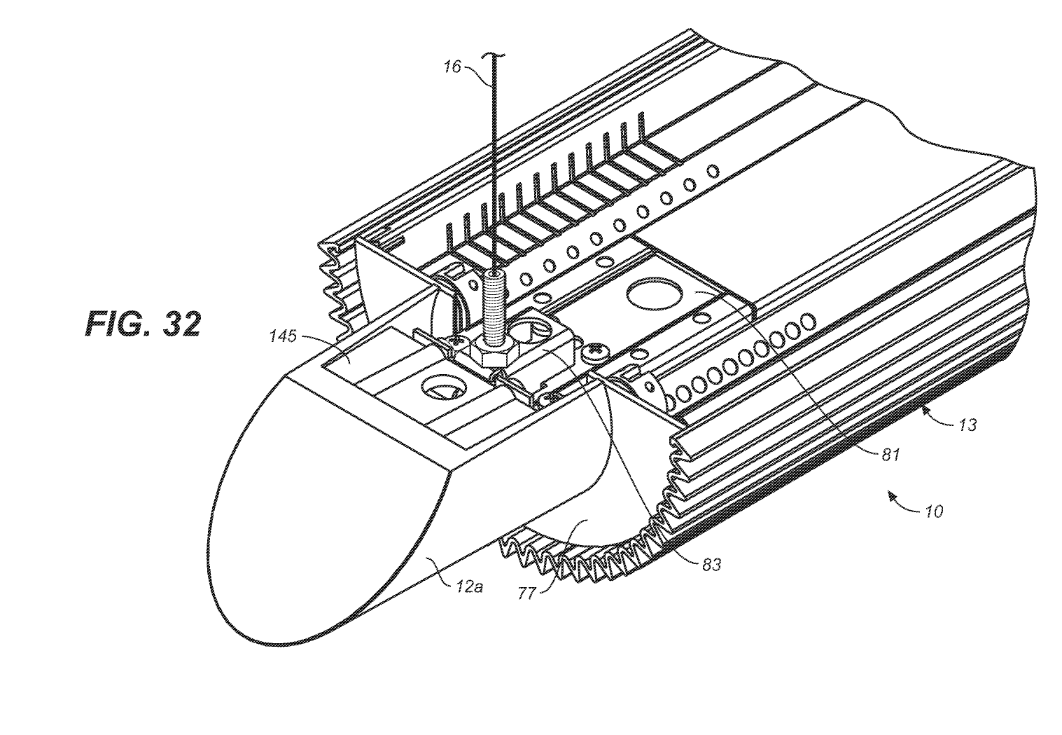

FIGS. 31 and 32 show a bracket assembly 80 installed as described above at the end of a run a spinal sections. At this end the filler cap 14 would not be used and, if pre-installed at this end, would be removed. Instead, a modified version of the above-described end cap 12 would be installed. (The modified version of the end cap is denoted by the numeral 12a.) The end cap 12a, which has a recessed top wall 145 with longitudinal screw hole bosses, is attached to the vertical joiner plate 107 of the joiner bracket 83 by attachment screws 149.

It will be understood that the optical shade assemblies 13 which are installable on the spinal structure of the lighting system of the invention could comprise optical elements other than those illustrated in the drawings, including prismatic lenses, louvers, screens, and the like. In each case, the optical elements will be configured into an optical shade assembly that surrounds the in-line fluorescent lamps or banks of fluorescent lamps supported on the spinal structure of the lighting system.

While embodiments of the invention has been described herein in considerable detail in the foregoing specification, it will be understood that it is not intended that the invention be limited to such detail, except as necessitated by the following claims.

What we claim is:

1. A linear lighting system configurable into one or a continuous run of lighting elements, comprising
an elongated spinal structure adapted to be installed below or adjacent a ceiling or wall surface and providing a wire-way and a ballast containment structure, said spinal structure including means for supporting at least one lamp socket thereon for holding at least one lamp, wherein the at least one lamp socket can be wired from the wire-way of said spinal structure, and
at least one elongated optical assembly containing at least two optical components for the lighting system and being separately attachable to said spinal structure after said spinal structure has been installed at a building site, said at least one optical assembly having sufficient length to extend over a lamp held in the at least one lamp socket supported on said spinal structure when the optical assembly is attached to said spinal structure, such that the optical components of said shade assembly provide optical control over the light emitted by such lamp.

2. The lighting system of claim 1 wherein said spinal structure is comprised of a channel housing having a small cross-sectional profile in relation to its length, wherein said channel provides said wire-way and ballast containment structure, wherein said at least one elongated optical assembly is attachable to said channel housing after said spinal structure has been installed at a building site.

3. The lighting system of claim 2 wherein the means for supporting at least one lamp socket on said spinal structure comprises at least one bracket structure on the top of said channel housing.

4. The lighting system of claim 3 wherein said bracket structure further includes means for suspending the spinal structure from a surface.

5. The lighting system of claim 1 wherein said spinal structure is provided in the form of separate elongated spinal sections having joinable spinal section ends.

6. The lighting system of claim 5 wherein each joinable spinal section comprises a bracket structure at each of its spinal section ends for supporting at least one lamp socket at the spinal section ends.

7. The lighting system of claim 6 wherein the bracket structures of each spinal section includes means for joining together the ends of two spinal sections.

8. The lighting system of claim 6 wherein the bracket structures of each spinal section includes means for suspending the ends the spinal sections from a surface.

9. The lighting system of claim 6 wherein the bracket structures of each spinal section includes means for joining together the ends of two spinal sections and means for suspending the ends the spinal sections from a surface.

10. The lighting system of claim 1 wherein said optical assembly includes at least one reflector component that extends below the lamp held in the at least one lamp socket of the spinal structure.

11. The lighting system of claim 1 wherein said optical assembly includes at least one reflector component and at least one a shade component.

12. The lighting system of claim 11 wherein, when said optical assembly is attached to said spinal structure, the reflector component thereof extends beneath the lamp held by said at least one lamp socket, and wherein said shade component is positioned below said reflector component, and further wherein said reflector component includes distributed openings therein to allow light emitted by the lamp held in the at least one lamp socket on said spinal structure to be passed through the reflector component and thence through said shade component.

13. The lighting system of claim 12 wherein said shade components is comprised of a diffuser cover beneath said reflector component.

14. The lighting system of claim 1 wherein said spinal structure terminates at two ends, and wherein aesthetic end caps are provided for extending the linear form of the lighting system at the two of said spinal structure.

15. The lighting system of claim 1 wherein said spinal structure includes more than one lamp socket for holding at least two lamps or banks of lamps spaced along the length of said spinal structure, and wherein at least two elongated optical assemblies are provided, each of said optical assemblies being attachable to the spinal structure for covering one of the lamps or banks of lamps spaced along the spinal structure.

16. The lighting system of claim 15 wherein a space is created between the optical assemblies when attached to said spinal structure thereby exposing a portion of said spinal structure, and wherein at least one aesthetic filler cap is provided, said filler cap being attachable to said spinal structure in the space or spaces between said optical assemblies for hiding the exposed portion or portions of the spinal structure.

17. The lighting system of claim 16 wherein said spinal structure terminates at two ends, and wherein aesthetic end caps are provided for extending the linear form of the lighting system at the two of said spinal structure.

18. The lighting system of claim 17 wherein said end caps and said at least one filler cap have complimentary forms.

19. A linear fluorescent lighting system configurable into one or a continuous run of lighting elements, comprising
an elongated spinal structure having a small cross-sectional profile in relation to its length and being adapted to be installed below or adjacent a ceiling or wall surface, said spinal structure providing a wire-way and a ballast containment structure for the linear fluorescent lighting system, said spinal structure including means for supporting at least one lamp socket on the spinal structure for holding at least one fluorescent lamp wherein the at least one lamp socket can be wired from the wire-way of said spinal structure, and
at least one elongated optical shade assembly comprised of a reflector component and a shade component and being separately attachable to said spinal structure after said spinal structure has been installed at a building site, said at least one optical assembly having sufficient length to cover a lamp held in the at least one lamp socket supported on said spinal structure when the optical assembly is attached to said spinal structure, the reflector and shade components of said shade assembly providing optical control over the light emitted by such fluorescent lamp, and the shade component of the optical system appearing as a linear lighting element on said spinal structure.

20. The lighting system of claim 19 wherein said spinal structure is comprised of
at least two channel housing sections installable as a run of channel housing sections, wherein said run of channel housing sections provide said wire-way and ballast containment structure, and
at least one socket support bracket structure on the top of each channel housing section for supporting at least on lamp socket per channel housing section, said bracket structures being adapted for suspending the channel housing section from a surface,
and wherein at least one elongated optical assembly is provided for each channel housing section, each of said optical assemblies being attachable to the channel housing section for covering the fluorescent lamp held in the at least one lamp socket on said channel housing section.

21. The lighting system of claim 20 wherein a space is created between the optical shade assemblies when attached to said channel housing sections thereby exposing a portion of the channel housing of said spinal structure, and wherein at least one aesthetic filler cap is provided, said filler cap being securable in the space between optical assemblies for hiding exposed portion or portions of the channel housing.

22. The lighting system of claim 21 wherein the run of channel housing sections terminates at two ends, and wherein aesthetic end caps are provided for extending the linear form of the lighting system at the two ends of said run of channel housing sections.

23. The lighting system of claim 22 wherein said end caps and said at least one filler cap have complimentary forms.

24. A linear fluorescent lighting system configurable into one or a continuous run of lighting elements, comprising
elongated spinal sections, each of which is adapted to be installed below or adjacent a ceiling or wall surface, and all of which are adapted to be joined together in a continuous run of spinal sections for providing a continuous wire-way and a ballast containment structure, each of said spinal sections including means for supporting at least one lamp socket on said spinal section for holding at least one fluorescent lamp thereon wherein the at least one lamp socket of the spinal section can be wired from the wire-way in said spinal section, and
at least one elongated optical shade assembly for each of said spinal sections, each of said optical shade assemblies being comprised of a reflector component and a shade component, and being separately attachable to one of said spinal sections after the run of spinal sections has been installed at a building site, each of said assemblies having sufficient length to cover a fluorescent lamp held in the at least one lamp socket supported on a spinal section when the optical assembly is attached to such spinal section, the reflector and shade components of said shade assemblies providing optical control over the light emitted by such fluorescent lamps of said spinal sections, and the optical assemblies providing an appearance of repeating linear lighting elements along the continuous run of spinal structure sections.
